(19) United States
(12) Patent Application Publication
(10) Pub. No.: US 2017/0248476 A1
(43) Pub. Date: Aug. 31, 2017

(54) RESISTANCE TEMPERATURE DETECTION WITH SINGLE CURRENT SOURCE CURRENT SPLITTER

(71) Applicant: GE Intelligent Platforms Embedded Systems, Inc., Charlottesville, VA (US)

(72) Inventors: Alan Carroll Lovell, Salem, VA (US); Bruce Henderson, Salem, VA (US)

(21) Appl. No.: 15/514,104

(22) PCT Filed: Sep. 29, 2014
(86) PCT No.: PCT/US2014/058083

§ 371 Date: Mar. 24, 2017

(51) Int. Cl. G01K 7/22

(52) U.S. Cl. CPC G01K 7/22

(57) ABSTRACT

A RTD measurement device comprises a current splitter connected to a single current source. The current splitter splits the current from the current source into two currents and continuously monitors the two currents and adjusts them to be the same value.

### TECHNICAL FIELD

The technical field relates generally to systems and methods for measurement of a resistor thermal device and more specifically to measurement using a three-wire device.

### BACKGROUND

A three-wire resistance temperature detector (RTD) when compared to a four-wire RTD requires more complex measurement circuits to compensate for wire voltage drop due to the fact that a Kelvin connection cannot be made with fewer than four wires. Several compensation methods exist: The first method creates one excitation current and makes two voltage measurements. A calculation must be made either in hardware (error amplifiers) or software to combine the voltages. Both voltages must be measured, and one current must be well-known or measureable.

A second method uses two equal currents and makes one voltage measurement. A calculation is not required because the currents cancel the wire drops, but two currents must be matched and voltage must be measured and the current must be known or measureable. Other methods exist with several variations in which one current is time multiplexed with various switches so that a time multiplexed voltage measurement is capable of measuring RTD voltage and wire drop voltage. This method requires the hardware or software calculation for compensating.

The second method of using two equal currents is generally preferred because it does not require complex calculation. Attempts have been made to realize measurements using the second method. One approach creates two current sources that are well matched and well known and then makes a voltage measurement. Another approach uses two current sources that are well matched but not well known and then makes a voltage measurement and a current measurement. These two approaches require two well matched current sources supported by complex circuitries or rely upon IC manufacturing processes to adjust parameters that are difficult to control with high accuracy.

Therefore, it is to a system and method that enables measurement of a RTD without requiring complex calculation or two well matched current sources, the present invention is primarily directed.

### SUMMARY

In one embodiment, the present invention is an apparatus, for measurement of a resistance temperature detector (RTD). The apparatus comprises a current splitter. The current splitter is connected to a current source and receives a source current from the current source. The current splitter also provides a first current on a first current path and a second current on a second current path. A first current path is connected to a first end of the RTD and a second current path is connected to a second end of the RTD. The first current and the second current are adjusted by the current splitter. A control signal may he used to control the current splitter.

In another embodiment, the present invention is a DC current splitter used for measurement of a RTD device. The DC current splitter comprises a third resistor connected to a current source, a first transistor connected to the third resistor and the first resistor and controlled by the control signal from the external source, a fourth resistor connected to the current source, a second transistor connected to the fourth resistor and the second resistor, and an operational amplifier connected to the third resistor and to the fourth resistor and outputting an output voltage to control the second transistor.

In another embodiment, the present invention is an AC current splitter used for measurement of a RTD device. The AC current splitter comprises a first switch connected to a current source, a second switch connected to the current source, an input for receiving the control signal, and an inverter tor receiving the control signal and outputting an inverted control signal to the second switch. The control switch controls the first switch and the inverted control signal controls the second switch.

In yet another embodiment, the present invention is a method for measuring a resistor-thermal device (RTD). The method comprises receiving a source current by a current splitter, generating a first current and a second current by the current splitter, adjusting the first current and the second current by the current splitter, measuring the first current, and measuring a voltage across the RTD.

The foregoing has broadly outlined some of the aspects and features of the various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE DRAWINGS

FIG. 1 is a schematic diagram according to the present invention;

FIG. 2 is a DC implementation according to the present invention;

FIG. 3 is an AC implementation according to the present invention;

FIG. 4 illustrates a process for measuring temperature of the RTD according to one embodiment or the present invention;

FIG. 5 illustrates a process for controlling the current splitter of the present invention; and

FIG. 6 is an alternative embodiment of an AC implementation of the present invention.

### DETAILED DESCRIPTION OF THE INVENTION

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The operational amplifier (op amp) and error amplifier are used interchangeably in this specification. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to he interpreted as limiting, but merely as a basis for the claims and as a representative basis for teaching one skilled in the art.

The present invention introduces a system and method that connects to a single current source and splits the single source current into two currents. The system continuously adjusts the currents to ensure two currents are substantially the same. The first current passes through a RTD and merges with the second current at a node after the RTD. The first current is measured and the voltage across the RTD is also measured. After knowing the first current and the voltage across the RTD, the resistance of the RTD is easily determined and the temperature of the RTD is obtained through a chart using the resistance of the RTD.

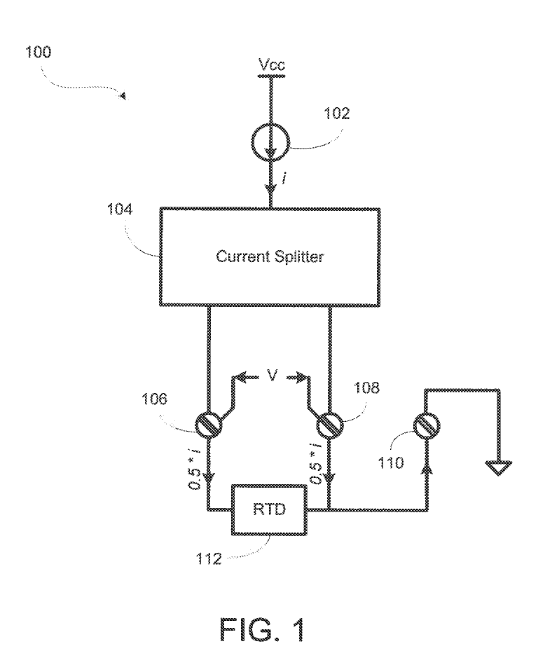

FIG. 1 is a schematic diagram 100 of a circuit according to the present invention. The circuit 100 includes a current source 102 connected to a current splitter 104. A first current from the current splitter 104 passes through a first path that includes screw 106 and a RTD 112. A second current from the current splitter 104 passes through a second path that includes screw 108 and merges with the first current and the merged current flows through screw 110. The current splitter 104 splits the source current from the current source 102 and continuously adjusts and maintains the first and second currents to be substantially the same.

When using the circuit of the FIG. 1, the voltage V across the RTD 112, measured between the screws 106 and 108, can be easily determined.

V=0.5*i*RW+0.5*i*RRTD−0.5*i*RW; (1)

wherein i—current from the current source 102;
RW—resistance of the wire between the screw and the RTD;
RRTD—resistance of the RTD;

The RTD wires have equal length and the resistance of three wires is substantially the same. The equation (1) can be simplified to:

V=0.5*i*(RW+RRTD−RW); (2)

V=0.5*i*RRTD; (3)

RRTD=V/(0.5*i); (4)

After RRTD is determined, the temperature of the RTD can be obtained based on the thermal characteristics of the RTD.

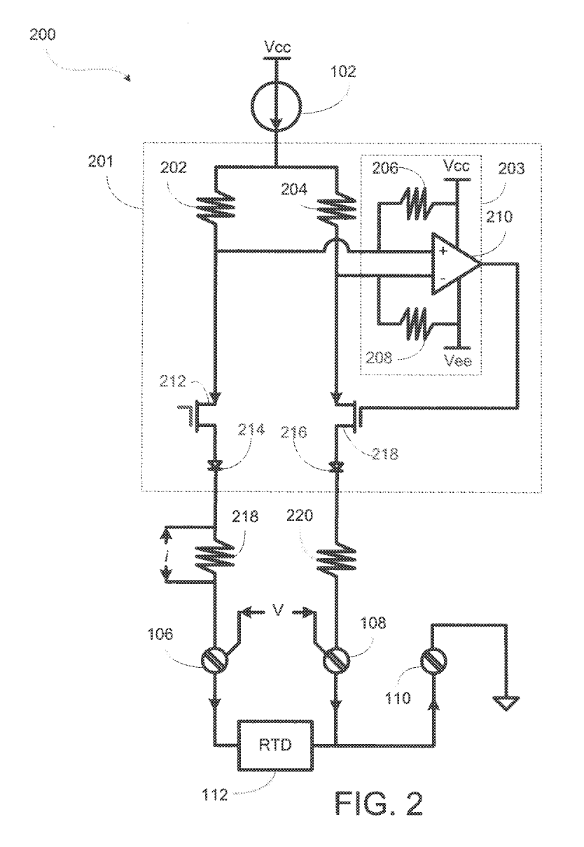

FIG. 2 is a circuit 200 implementing the schematic diagram 100. The current source 102 is connected to a DC current splitter 201. The DC current splitter 201 includes two current paths, A first current path includes a resistor 202, a MOSFET 212 operating in the saturation region, and a diode 214 and the second current path includes a resistor 204, a MOSFET 218 controlled by a current controller 203, and a diode 216. The current controller 203 comprises an error amplifier 210 connected to both the first current path and the second current path. The current controller 203 is also connected to a first voltage source Vcc and a second voltage source Vee, One input of the error amplifier 210 is connected through a bias resistor 206 to the Vcc and other input of the error amplifier 210 is connected through another bias resister 208 to the Vee. The MOSFET 212 is controlled by an external control logic (not shown). The current controller 203 outputs a voltage that controls the MOSFET 218 and the MOSFET 218 operates in the linear region (Triode mode). The voltage outputted by the current controller 203 changes according to the difference in the currents passing through the first current path and the second current path. When the current in resistor 204 is less than the current in resistor 202, the voltage from the current controller 203 decreases, which increases the overdrive voltage in the MOSFET 218, which in turn increases the drain current of the MOSFET 218. When the current in resistor 204 is greater than the current in resistor 202, the voltage from the current controller 203 increases, which decreases the overdrive voltage of the MOSFET 218, which in turn decreases the drain current of the MOSFET 218. This describes negative feedback that allows the current controller 203 to create a second current, which is equal to the first current.

The current from the first current path passes through a resistor 218, a screw 106, and a RTD 112. The current from the second current path passes a resistor 220 and a screw 108 and merges with the current from the first current path. The current i flowing through resistor 218 is measured and the voltage V across screws 106 and 108 is also measured. After knowing the current i and the voltage V, the resistance value R of the RTD can be easily determined and the temperature T of the RTD can be obtained from the thermal characteristics of the RTD.

When MOSFET 212 is disabled by the external control logic (not shown), the current on the first current path is interrupted and ceases to flow into the RTD. Bias resistors 206 and 208 tip the error amplifier input so that the error amplifier 210 output disables the MOSFET 218 which interrupts the current on the second current path. Diodes 214 and 216 complete the bidirectional blocking operation of 212 and 218.

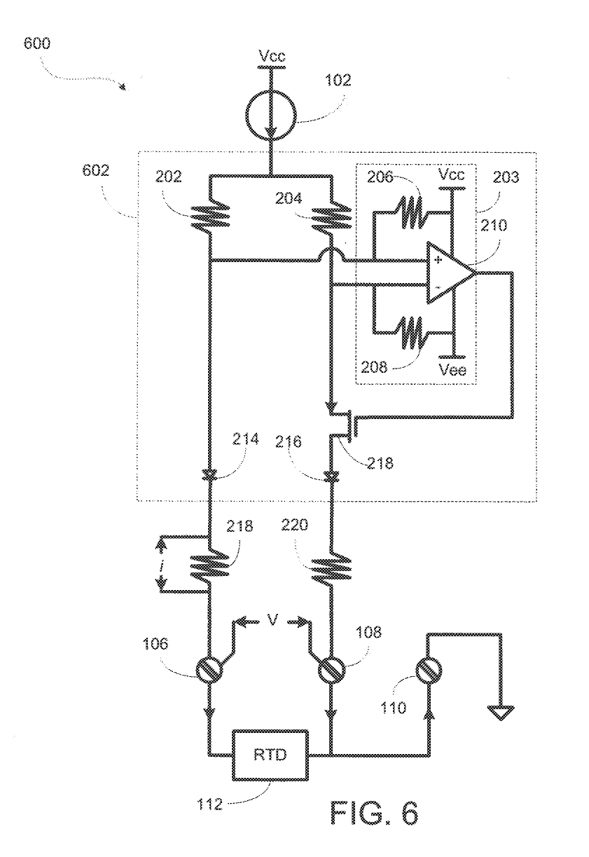

The MOSFET 212 can be optionally removed as shown in schematic 600 in FIG. 6. When the MOSFET 212 is removed from the current splitter 602, the current splitter 602 cannot be disabled as described above; however, the current splitter 602 will operate the same way as described above.

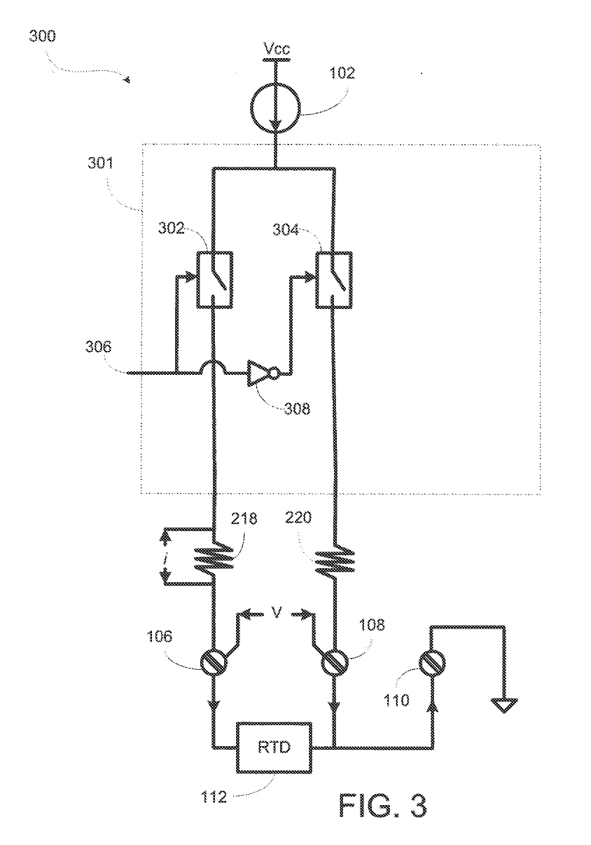

FIG. 3 is a circuit 300 according to an alternative embodiment of the schematic diagram 100. The current source 102 is connected to an AC current splitter 301. The AC current splitter 301 receives a control signal 306 from an external control logic (not shown) and outputs two currents. The AC current splitter 301 provides a first current path and a second current path. The first current path connects the current source 102 to a first switch 302. The second current path connects the current source 102 to a second switch 304. The first switch 302 is controlled by the control signal 306 and the second switch 304 is controlled by the inverted control signal 306, which is the control signal 306 after passing through an inverter 308. The first switch 302 and the second switch 304 work alternately, such that one conducts current while other is shut off. The polarity of the control signal 306 switches with a high frequency, causing the first switch 302 and the second switch 304 to toggle rapidly and consequently the current from the current source 102 to flow alternatively on the first current path and the second current path.

The current i flowing through the resistor 218 can be measured with a current meter equipped with a low pass filter to filter out the switching aspect of the measurement result. The voltage V across the screws 106 and 108 is also measured with a voltage meter equipped with a low pass filter to filter out the switching aspect of the measurement result. Similar to the circuit shown in FIG. 2, the temperature of the RTD 112 can be obtained after the resistance R across the RTD 112 is determined using the measured current i and voltage V.

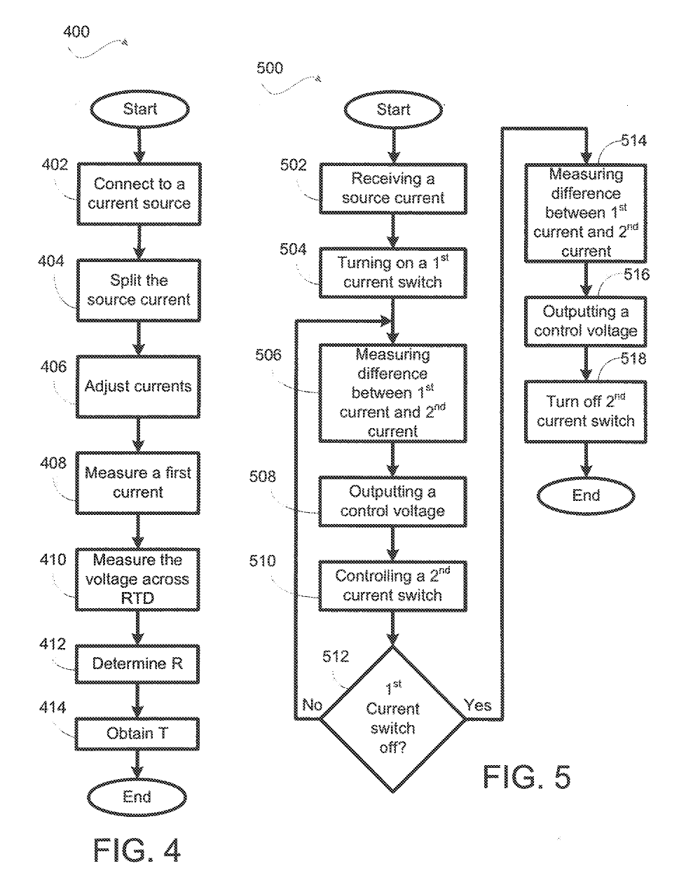

FIG. 4 is a process 400 for measuring the temperature of a RTD. A current splitter is connected to a current source, step 402, and the current splitter splits the current from the current source, step 404, into two currents. The current splitter adjusts the currents, step 406, to ensure both currents are substantially at the same level. One of the currents is measured, step 408, and it is also measured the voltage across the RTD, step 410. The resistance R of the RTD is determined, step 412, because the voltage V and the current i are known. After determining the resistance R, the temperature T of the RTD can he obtained by a table lookup, step 414. Alternatively, if the current splitter is connected to a current source providing a known current, the current through the RTD would be half of the known current and one measurement of the voltage across the RTD would be needed to determine the resistance R of the RTD.

FIG. 5 is a process 500 for operating a current splitter. The current splitter is connected to a current source and receives a source current, step 502. The first current switch in the current splitter is turned on, step 504, to allow the first current to flow through the first current path. The difference between the first current flowing through the first current path and the second current flowing through the second current path is measured, step 506, by the current controller. The current controller in the current splitter outputs a control voltage according to the difference between the first current and the second current, step 508, and the control voltage controls a second current switch, step 510. The second current flowing through the second current path varies according to the second current switch. If the first current switch has not been turned off, step 512, the steps 506, 508, and 510 will be repeated and the control voltage is continuously adjusted to ensure that the first current and second current are substantially the same.

If the first current switch has been turned off, which causes the first current to stop, the current controller measures the difference between the first current and the second current, step 514, and the current controller outputs a control signal, step 516, which turns off the second current switch, step 518.

This invention allows a single, standard error amplifier to create two equal currents which is a hybrid of the first and second methods of the prior art, single current source and dual current source methods, respectively. The two current method from the present invention is capable of shared-wire, grounded RTD connection methods used by heavy duty gas turbines. The accuracy of the circuit 200 of the present invention is limited only by the matching of resistors 202 and 204, the offset error voltage of the error amplifier 210, and the triode mode of the MOSFET 218.

The present invention is a hybrid method and it is simpler and improves accuracy of RTD measurement. A single source current is required and must be well known or measurable. A single op amp (error amplifier) circuit creates a current splitter that creates two current paths, each of half the magnitude of the source current. One voltage is measured. Alternatively, a time-multiplexed current (AC) may also be used to create two current paths. The advantage of this improved, hybrid method is that for the cost of a single op amp, no compensation math is required (one or more op amps required), only one voltage must be measured, and only one current must he known or measureable.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims or if they include equivalent structural elements with insubstantial differences from the literal language of the claims. It is within the scope of the present invention that the features and devices described in different embodiments may be combined or interchanged.

What is claimed is:

1. An apparatus, for measuring a resistance temperature detector (RTD), comprising:
a current splitter, connected to a current source, receiving a source current from the current source, and providing a first current on a first current path and a second current on a second current path,
wherein the first current and the second current are adjusted by the current splitter and the first current path and the second current path are connected to the RTD.

2. The apparatus of claim 1, further comprising:
a first resistor connected to the first current path and to a first end of the RTD; and
a second resistor connected to the second current path and to a second end of the RTD.

3. The apparatus of claim 1, wherein the current splitter receives a control signal from an external source for the current splitter.

4. The apparatus of claim 2, wherein the current splitter further comprising:
a third resistor connected to the current source;
a first transistor connected to the third resistor and the first resistor and controlled by the control signal from the external source;
a fourth resistor connected to the current source;
a second transistor connected to the fourth resistor and the second resistor; and
an operational amplifier connected to the third resistor and to the fourth resistor and outputting an output voltage to control the second transistor.

5. The apparatus of claim 4, wherein the current sputter further comprising:
a first diode connected to the first transistor and the first resistor; and
a second diode connected to the second transistor and the second resistor,
wherein the first current path comprises the third resistor, the first transistor, and the first diode, and the second current path comprises the fourth resistor, the second transistor, and the second diode.

6. The apparatus of claim 4, wherein the first transistor operates in a saturation region.

7. The apparatus of claim 4, wherein the second transistor operates in an Ohmic region.

8. The apparatus of claim 4, wherein the current splitter further comprising two bias resistors connected to inputs of the operational amplifier.

9. The apparatus of claim 1, wherein the current splitter further comprising:
a first switch connected to the first current path and to a first end of the RTD; and
a second switch connected to the second current path and to a second end of the RTD, wherein the first switch and the second switch operate alternately.

10. The apparatus of claim 9, wherein the current splitter further comprising an inverter receiving the control signal and providing an inverted control signal to the second switch.

11. The apparatus of claim 1, wherein the current splitter further comprising:
a third resistor connected to the current source;
a fourth resistor connected to the current source;
a second transistor connected to the fourth resistor and the second resistor; and
an operational amplifier connected to the third resistor and to the fourth resistor and outputting an output voltage to control the second transistor.

12. The apparatus of claim 11, wherein the current splitter further comprising:
a first diode connected to the first resistor and the third resistor; and
a second diode connected to the second transistor and the second resistor,
wherein the first current path comprises the third resistor and the first diode, and the second current path comprises the fourth resistor, the second transistor, and the second diode.

13. The apparatus of claim 11, wherein the second transistor operates in an Ohmic region.

14. The apparatus of claim 1, wherein the current splitter further comprising:
a first switch connected to the current source;
a second switch connected to the current source;
an input for receiving the control signal; and
an inverter for receiving the control signal and outputting an inverted control signal to the second switch,
wherein the control switch controls the first switch and the inverted control signal controls the second switch.

15. The apparatus of claim 14, wherein the current splitter further comprising:
a first diode connected to the first switch and the first resistor; and
a second diode connected to the second switch and the second resistor,
wherein the first current path comprises the first switch and the first diode, and the second current path comprises the second switch and the second diode.

16. A method, for measuring a resistor-thermal device (RTD), comprising the steps of: receiving a source current by a current splitter;
generating a first current and a second current by the current splitter;
adjusting the first current and the second current by the current splitter;
measuring the first current; and
measuring a voltage across the RTD.

17. The method of claim 16, further comprising the steps of:
determining a resistance for the RTD based on the measured voltage; and
obtaining a temperature for the RTD based on the resistance for the RTD.

18. The method of claim 16, further comprising the step of receiving a first control signal from an external source for turning on the current splitter.

19. The method of claim 16, wherein the step of adjusting he first current and the second current further comprises the steps of:
turning on a first current switch;
measuring a difference between the first current and the second current;
generating a second control voltage based on the difference measured; and
controlling a second current switch with the second control voltage.

20. The method of claim 16, further comprising the steps of:
turning off a first current switch;
measuring a difference between the first current and the second current;
generating a second control voltage based on the difference measured; and
turning off a second current switch with the second control voltage.
